(19) United States
(12) Patent Application Publication
(10) Pub. No.: US 2026/0001560 A1
(43) Pub. Date: Jan. 1, 2026

(54) VEHICLE AND METHOD OF CONTROLLING THE SAME USING ESTIMATED WEIGHT

(71) Applicants: Hyundai Motor Company, Seoul (KR); Kia Corporation, Seoul (KR)

(72) Inventor: Young Kwang Kim, Hwaseong-Si (KR)

(21) Appl. No.: 18/965,585

(22) Filed: Dec. 2, 2024

(30) Foreign Application Priority Data
Jun. 26, 2024 (KR) 10-2024-0083723

(51) Int. Cl. B60W 40/13; B60W 30/18

(52) U.S. Cl. CPC B60W 40/13; B60W 2556/10; B60W 2556/45

(57) ABSTRACT

A weight estimation method may include: determining, based on a quantity of one or more weight estimations that have been applied to vehicle data and based on a variation condition being satisfied, a forgetting factor; determining estimated weight information of the vehicle by applying, to the vehicle data, a weight estimation that is based on recursive least squares (RLS) associated with the forgetting factor; updating the estimated weight information by repeatedly applying, to the vehicle data and until a total quantity of weight estimations that have been applied to the vehicle data reaches a threshold value, one or more additional weight estimations that are based on RLS associated with a variable forgetting factor, wherein the variable forgetting factor is updated based on a current quantity of weight estimations that have been applied to the vehicle data; and controlling, based on the updated estimated weight information, the vehicle.

### CROSS REFERENCE TO RELATED APPLICATION

The present application claims priority to a Korean provisional application No. 10-2024-0083723, filed Jun. 26, 2024, the entire contents of which are incorporated herein for all purposes by this reference.

### TECHNICAL FIELD

The present disclosure relates to a method and a vehicle for controlling a vehicle, and more particularly controlling a vehicle based on an estimated weight.

### BACKGROUND

Weight estimation includes calculations of complex factors during driving such as vehicle speed, motor torque feedback, powertrain efficiency and driving resistance. Powertrain efficiency and other factors may be difficult to accurately model. In For reliable weight estimation, a forgetting factor of recursive least square (RLS) may be set to be close to 1. Thus, accuracy needs to be improved so that many measurements can be utilized for weight estimation.

However, in the case of large commercial vehicles, where the difference between an empty vehicle weight and a loaded vehicle weight can have a wide range, for example, anywhere between 14 tons and 36 tons, effectively doubling the weight of the vehicle, it may take a long time for an initial assumed value, which is typically based on a median value such as 25 tons, to converge on the actual weight. For example, it may take more than 10 minutes for the initial assumed value of 25 tons to converge on an actual weight of 14 tons. Accordingly, when a weight-adapted torque and regenerative braking control are applied, the vehicle control may experience a disparity during the initial convergence time, which in turn may become a factor in degrading the quality of the vehicle.

### SUMMARY

The present disclosure is technically directed to providing a method and a vehicle for estimating a weight based on RLS with a forgetting factor, which enable a weight estimation in the vehicle to quickly converge and an accurate estimated weight to be obtained in situations of an initial stage of start-up and a sudden change of vehicle weight, thereby maximizing stability of vehicle control.

The technical problems solved by the present disclosure are not limited to the above technical problems and other technical problems which are not described herein will be clearly understood by a person having ordinary skill in the technical field, to which the present disclosure belongs, from the following description.

According to one or more example embodiments of the present disclosure, a method performed by an apparatus of a vehicle may include: determining, based on a quantity of one or more weight estimations that have been applied to vehicle data and based on a variation condition being satisfied, a forgetting factor; determining estimated weight information of the vehicle by applying, to the vehicle data, a weight estimation that is based on recursive least squares (RLS) associated with the forgetting factor; and updating the estimated weight information by repeatedly applying, to the vehicle data and until a total quantity of weight estimations that have been applied to the vehicle data reaches a threshold value, one or more additional weight estimations that are based on RLS associated with a variable forgetting factor. The variable forgetting factor may be updated based on a current quantity of weight estimations that have been applied to the vehicle data. The method may further include controlling, based on the updated estimated weight information, the vehicle.

As the current quantity of weight estimations that have been applied to the vehicle data increases, the variable forgetting factor may increase and a forgetting feature of the variable forgetting factor may decrease.

An increase in the variable forgetting factor may be proportional to an increase in the current quantity of weight estimations that have been applied to the vehicle data.

The method may further include, based on the total quantity of weight estimations reaching the threshold value: determining a fixed forgetting factor by stopping updating the variable forgetting factor; and updating the estimated weight information by applying, to the vehicle data, an additional weight estimation that is based on RLS associated with the fixed forgetting factor.

The fixed forgetting factor may be greater than the variable forgetting factor. The fixed forgetting factor may have a lower forgetting feature than the variable forgetting factor.

The method may further include determining whether the variation condition is satisfied, based on at least one of: a difference in the estimated weight information between two time frames being greater than a threshold difference, or a reset state in which the vehicle transitions from an OFF state to an ON state.

Updating the estimated weight information may include: determining filtered estimated weight information by applying an adaptive rate-limit filter to the estimated weight information.

Determining the filtered estimated weight information may include determining the filtered estimated weight information by filtering current estimated weight information such that a difference between the current estimated weight information and previous filtered estimated weight information is between an upper limit value and a lower limit value of the adaptive rate-limit filter. The upper limit value and the lower limit value may be determined according to a difference between previous estimated weight information before filtering and the previous filtered estimated weight information.

Determining the filtered estimated weight information may include at least one of: determining the filtered estimated weight information by limiting the current estimated weight information to a sum of the previous filtered estimated weight information and the upper limit value, based on the current estimated weight information being greater than the previous filtered estimated weight information by at least the upper limit value; or determining the filtered estimated weight information by limiting the current estimated weight information to the previous filtered estimated weight information, based on the current estimated weight information being greater than the previous filtered estimated weight information by less than the upper limit value.

Determining the filtered estimated weight information may include at least one of: determining the filtered estimated weight information by limiting the current estimated weight information to a value obtained by subtracting the lower limit value from the previous filtered estimated weight information, based on the current estimated weight information being less than the previous filtered estimated weight information by at least the lower limit value; or determining the filtered estimated weight information by limiting the current estimated weight information to the previous filtered estimated weight information, based on the current estimated weight information being less than the previous filtered estimated weight information by less than the lower limit value.

According to one or more example embodiments of the present disclosure, a vehicle may include: a memory storing at least one instruction; and a processor configured to execute the at least one instruction stored in the memory to: determine, based on a quantity of one or more weight estimations that have been applied to vehicle data and based on a variation condition being satisfied, a forgetting factor; determine estimated weight information of the vehicle by applying, to the vehicle data, a weight estimation that is based on recursive least squares (RLS) associated with the forgetting factor; and update the estimated weight information by repeatedly applying, to the vehicle data and until a total quantity of weight estimations that have been applied to the vehicle data reaches a threshold value, one or more additional weight estimations that are based on RLS associated with a variable forgetting factor. The variable forgetting factor may be updated based on a current quantity of weight estimations that have been applied to the vehicle data. The processor may be configured to execute the at least one instruction stored in the memory further to control, based on the updated estimated weight information, the vehicle.

As the current quantity of weight estimations that have been applied to the vehicle data increases, the variable forgetting factor may increase and a forgetting feature of the variable forgetting factor may decrease.

An increase in the variable forgetting factor may be proportional to an increase in the current quantity of weight estimations that have been applied to the vehicle data.

The processor may be configured to execute the at least one instruction stored in the memory further to, based on the total quantity of weight estimations reaching the threshold value: determining a fixed forgetting factor by stopping updating the variable forgetting factor; and update the estimated weight information by applying, to the vehicle data, an additional weight estimation that is based on RLS associated with the fixed forgetting factor.

The fixed forgetting factor may be greater than the variable forgetting factor. The fixed forgetting factor may have a lower forgetting feature than the variable forgetting factor.

The processor may be configured to execute the at least one instruction stored in the memory further to determine whether the variation condition is satisfied, based on at least one of: a difference in estimated weight information between two time frames being greater than a threshold difference, or a reset state in which the vehicle transitions from an OFF state to an ON state.

The processor may be configured to execute the at least one instruction stored in the memory to update the estimated weight information by: determining filtered estimated weight information by applying an adaptive rate-limit filter to the estimated weight information.

The processor may be configured to execute the at least one instruction stored in the memory to determine the filtered estimated weight information by determining the filtered estimated weight information by filtering current estimated weight information such that a difference between the current estimated weight information and previous filtered estimated weight information is between an upper limit value and a lower limit value of the adaptive rate-limit filter. The upper limit value and the lower limit value may be determined according to a difference between previous estimated weight information before filtering and the previous filtered estimated weight information.

The processor may be configured to execute the at least one instruction stored in the memory to determine the filtered estimated weight information by at least one of: determining the filtered estimated weight information by limiting the current estimated weight information to a sum of the previous filtered estimated weight information and the upper limit value, based on the current estimated weight information being greater than the previous filtered estimated weight information by at least the upper limit value or more; or determining the filtered estimated weight information by limiting the current estimated weight information to the previous filtered estimated weight information, based on the current estimated weight information being greater than the previous filtered estimated weight information by less than the upper limit value.

The processor may be configured to execute the at least one instruction stored in the memory to determine of the filtered estimated weight information by at least one of: determining the filtered estimated weight information by limiting the current estimated weight information to a value obtained by subtracting the lower limit value from the previous filtered estimated weight information, based on the current estimated weight information being less than the previous filtered estimated weight information by at least the lower limit value; or determining the filtered estimated weight information by limiting the current estimated weight information to the previous filtered estimated weight information, based on the current estimated weight information being less than the previous filtered estimated weight information by less than the lower limit value.

The features of the present disclosure, which are briefly summarized herein, are only examples of aspects of features of the present disclosure and detailed description of the disclosure which follows and are not intended to limit the scope of the present disclosure.

The technical problems solved by the present disclosure are not limited to the above-mentioned technical problems. Other technical problems solved by the present disclosure, which are not described herein should be more clearly understood by a person having ordinary skill in the art of technical field to which the present disclosure belongs, from the following description.

According to the present disclosure, it is possible to provide a method and a vehicle for estimating a weight based on RLS with a forgetting factor, which enable a weight estimation in the vehicle to quickly converge and an accurate estimated weight to be obtained in situations of an initial stage of start-up and a sudden change of vehicle weight, thereby maximizing stability of vehicle control.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

FIG. 1 shows an example of a vehicle communicating with another device to transmit and receive data.

FIG. 2 shows an example of constituent modules of a vehicle.

FIG. 3 is a block diagram of a system that implements weight estimation in a vehicle.

FIG. 4 shows an example of functional modules of a weight estimation unit.

FIG. 5 shows an example of RLS logic that is applied to a weight estimator.

FIG. 6 is a flowchart of a method for estimating a weight.

FIG. 7 shows an example of a process of determining a forgetting factor.

FIG. 8 shows an example of vehicle data used in an existing weight estimation method and a weight estimation method.

FIG. 9 shows an example of data of results of application of the existing weight estimation method and the weight estimation method.

### DETAILED DESCRIPTION

Herein after, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and when drawings illustrated in the present specification are inversed, the location relations described in the specification may be inversely understood. When a component, device, element, or the like of the present disclosure is described as having a purpose or performing an operation, function, or the like, the component, device, or element should be considered herein as being “configured to” meet that purpose or perform that operation or function.

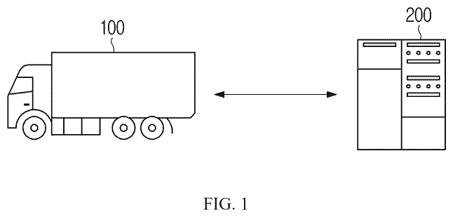

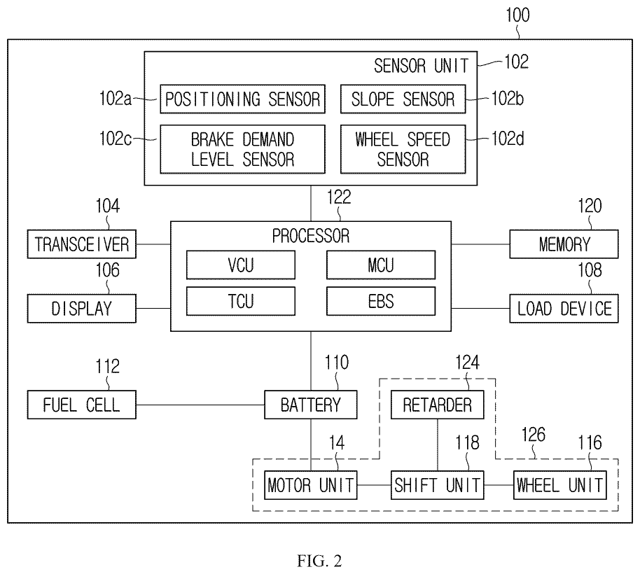

Hereinafter, with reference to FIG. 1 and FIG. 2, a vehicle implementing driving control using adaptive regenerative braking will be described. FIG. 1 is a view exemplifying a vehicle communicating with another device to transmit and receive data.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., weight estimation features) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., weight estimation features) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., weight estimation features) described herein.

Minimum risk maneuver (MRM) operation(s) may also be controlled, for example, based on one or more features (e.g., weight estimation features) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., weight estimation features) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., weight estimation features) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.)

Referring to FIG. 1, a vehicle 100 may be driven based on electric energy. In the case of electric energy, for example, the vehicle 100 may be a pure battery-based vehicle driven only by a high-voltage battery or employ a gas-based fuel cell as an energy source. In the case of a fuel cell, the vehicle 100 may charge a high-voltage battery by power generation of the fuel cell and execute various functions required by the modules of the vehicle 100 by output power of the high-voltage battery. In addition, the fuel cell may use various types of gas capable of generating electric energy, and for example, the gas may be hydrogen. However, without being limited thereto, various gases are applicable.

For convenience of explanation, the present disclosure describes an example in which an electric energy vehicle is the fuel cell-based vehicle 100. However, the present disclosure is applicable to a vehicle where a high-voltage battery and a cell are of different types and which employs a method of charging the high-voltage battery by power generation of the cell to output power for the start-up and drive of the vehicle 100 and a load device 120. In addition, the present disclosure may also be applied to a vehicle that is driven only by an electric battery.

The vehicle 100 may refer to a device capable of moving. The vehicle 100 is a vehicle as a ground vehicle driven on the ground and may be a normal passenger vehicle or commercial vehicle, a mobile office, or a mobile hotel. The vehicle 100 may be a four-wheel vehicle, for example, a sedan, a sports utility vehicle (SUV), and a pickup truck and may also be a vehicle with five or more wheels, for example, a bus, a lorry, a container truck, and a heavy vehicle. Apart from the above-described example, the vehicle 100 may be a robot that is driven on the ground. The vehicle 100 may be implemented by manual driving or autonomous driving (either semi-autonomous or full-autonomous driving).

Meanwhile, the vehicle 100 may perform communication with another device 200 or another vehicle under the control of a communication control unit (CTU) mounted in the vehicle 100. For example, another device may include a server 200 for supporting various control, state management and driving of the vehicle 100, an ITS device for receiving information from an intelligent transportation system (ITS), and various types of user devices.

The vehicle 100 may communicate with another vehicle or another device based on cellular communication, wireless access in vehicular environment (WAVE) communication, dedicated short range communication (DSRC) or short range communication, or any other communication scheme.

For example, the vehicle 100 may use LTE as a cellular communication network, a communication network such as 5G, a Wi-Fi communication network, a WAVE communication network, and the like to communicate with the server 200 and another vehicle. As another example, DSRC used in the vehicle 100 may be used for vehicle-to-vehicle communication. A communication scheme among the vehicle 100, the server 200, another vehicle, and a user device is not limited what is described herein.

In order to support autonomous driving and various services for the vehicle 100, the server 200 may transmit various types of information and software modules used for controlling the vehicle 100 to the vehicle 100 as a response to a request and data transmitted from the vehicle 100 and a user device.

FIG. 2 is a view showing constituent modules of a vehicle.

The vehicle 100 may include a sensor unit 102, a transceiver 104, a display 106, and a load device 108.

The sensor unit 102 may be equipped with a detector for sensing various states, operations and situations that occur in the external environment and inside the vehicle 100. In addition, the sensor unit 102 may be equipped with various types of detectors that identify location information of the vehicle 100.

Specifically, the sensor unit 102 may include a positioning sensor 102a for obtaining location information of the vehicle 100, a slope sensor 102b, a brake demand level sensor 102c for detecting a brake demand level (brake position) and an acceleration demand level required by a user or the processor 122, and a wheel speed sensor 102d for measuring the speed of the vehicle 100.

The positioning sensor 102a may generate two-dimensional location data by measuring the latitude and longitude of the vehicle 100 or measure an altitude in addition to the two-dimensional location data.

For example, the slope sensor 102b may measure a stance of the vehicle 100 and a tilting angle of the vehicle 100 through a gyro sensor, an inertia sensor and the like. The processor 122 may calculate a gradient of a road, on which the vehicle 100 is running, or a gradient of the vehicle 100 based on a value measured from the slope sensor 102b.

The brake demand level sensor 102c may detect a demand level included in a user's braking request, and for example, sense a user's pedal maneuver amount through a brake pedal or the user's demand level through an acceleration interface. The brake demand level sensor 102d capable of measuring a user's pedal maneuver amount may be a brake point sensor (BPS).

The present disclosure mainly describes sensors of the sensor unit 102 described herein but may further include a sensor for detecting various situations not listed herein such as a camera, a Lidar sensor and a radar sensor.

The transceiver 104 may support mutual communication with the server 200, the neighboring vehicle 300, and the like. In the present disclosure, the transceiver 104 may transmit data generated or stored during driving to the server 200 and receive data and a software module transmitted from the server 200. In the present disclosure, the vehicle 100 may transmit and receive data used in a method according to the present disclosure to and from the outside through the transceiver 104. In the present disclosure, the transceiver 104 may receive and forward map information and situation information to the memory 120 and the processor 122.

The display 106 may serve as a user interface. By the processor 122, the display 108 may display an operating state and a control state of the vehicle 100, route information according to navigation, traffic information around the vehicle 100, information on a remaining energy quantity, a content requested by a driver, and the like to be output. The display 106 may be configured as a touch screen capable of sensing a driver input and receive a request of a driver indicated to the processor 122.

The load device 108 may be an auxiliary equipment mounted on the vehicle 100, which consumes power supplied from the battery 110 by use of an occupant or a user. In the present disclosure, the load device 108 may be a type of electric device for non-driving purpose excluding a driving power system like the motor unit 110 for wheel drive. For example, the load device 108 may be an air-conditioning system, a light system, a seat system, and various devices installed in the vehicle 100.

The vehicle 100 may include the battery 110, a fuel cell 112, a motor unit 114, a shift unit 118, a retarder 124 and a wheel unit 116. In the present disclosure, the motor unit 114, the shift unit 118, the retarder 124 and the wheel unit 116 may constitute a power-train component 126.

The vehicle 100 is a mobility with a plurality of wheels, and all the wheels may be driven by being connected, for example, with the motor unit 114. In the present disclosure, for convenience of explanation, the motor unit 114, the shift unit 118, and the wheel unit 116 are illustrated as a single unit in FIG. 2. According to the number of wheels of the vehicle 100, the motor unit 114, the shift unit 118, and the wheel unit 116 increase according to the number, but because the motor unit 114, the shift unit 118, and the wheel unit 116, which drive each wheel, have an actually same function, these members may be understood to represent modules that drive each wheel. As another example, only some of the wheels may be coupled with the motor unit 114, and wheels not coupled with the motor unit 114 may be driven by a wheel driven from a motor.

The battery 110 and the fuel cell 112 may both supply power permanently, or the battery 110 and the fuel cell 112 may be used as a main power source and an auxiliary power source respectively.

The battery 110 may be a pure electric battery that is configured as a secondary cell charged by the fuel cell 112. In case regenerative braking is performed, the battery 110 may be charged by a counter electromotive force of the motor unit 114.

The fuel cell 112 may have a lower-voltage output than the battery 110 but may be configured to have a high energy density or a high charging capacity. As an example, the fuel cell 112 may be configured as a hydrogen-based fuel cell that generates electric energy through reaction between hydrogen gas filling a tank (not shown) from outside and oxygen flowing from a supplier (not shown).

The battery 110 may be charged by receiving a voltage that is output by a converter (not shown) that converts a voltage of the fuel cell 112. In addition, the converter 106 may supply power to a motor of the motor unit 114 and the load device 108, which are operated in a high voltage range, at a voltage converted from the fuel cell 112.

The motor unit 114 may generate a driving force by receiving electric power from the battery 110. The motor unit 114 may transmit a driving force to the wheel unit 116, and a wheel may be driven to rotate. For example, the motor unit 114 may be equipped with a motor for transmitting a driving force to the wheel unit 116 and a motor control module for controlling motor torque, a motor turning direction, and braking. The motor unit 114 may be driven by receiving electric power that is applied from the battery 110 via an inverter (not shown). An inverter may convert a specific form of electric power of the battery 110, for example, alternating current to another form, for example, direct current and reduce a voltage. The wheel unit 116 may include a wheel receiving a driving force of the motor unit 114, a main braking module for decelerating the drive of the wheel and a steering module for realizing horizontal control of the wheel.

The shift unit 118 may be equipped a mechanical component that transmits a driving force that is output from the motor unit 114 to the wheel unit 116. For example, the mechanical component may be a combination of a shaft and gears. As another example, the shift unit 118 may shift a driving force and transmit the shifted driving force to the wheel unit 116, together with a module for transmitting a driving force. In the case of a large vehicle, the shift unit 118 may be coupled with a brake assist module, for example, the retarder 124. For example, the retarder 124 may be equipped with a hydraulic or electromagnetic device for suppressing a rotation of a shaft that couples the wheel unit 116 and the motor unit 114. Following a user's brake assist request, the retarder may decelerate the vehicle 100 during downhill driving, irrespective of regeneration and main braking. The brake assist equipment and transmission described above may be omitted according to a specification of the vehicle 100.

In the present disclosure, the motor unit 114, the wheel unit 116, the shift unit 118 and the retarder 124 may constitute the power-train component 126.

In addition, the vehicle 100 may include the memory 120 and the processor 122.

The memory 120 may store an application for controlling the vehicle 100 and various data and load the application or read and record data at a request of the processor 122. In the present disclosure, in response to satisfaction of a variation condition and a predetermined number (e.g., quantity) of weight estimations (also referred to as a number or quantity of estimations), the memory 120 may variably determine a forgetting factor based on an increasing number of weight estimation times and generate estimated weight information based on vehicle data by weight estimation based on recursive least square (RLS) using the forgetting factor that is variably determined, or have an update application. In response to the number of weight estimations reaching a threshold number of estimations, an application managed in the memory 120 may set a fixed forgetting factor and update estimated weight information by a weight estimation using the fixed forgetting factor. In addition, in the update of the estimated weight information, the application may output filtered estimated weight information by applying an adaptive rate-limit filter to the estimated weight information.

The memory 120 may hold and manage map information for identifying a location of the vehicle 100. Map information may be used to generate a driving route set in the vehicle 100 at a request of a user or the processor 122 or to identify a location of the vehicle 100 such as a latitude, a longitude and an altitude. In addition, map information may be used to obtain driving situation information of a front route. In addition, map information may be used for autonomous driving and include a low definition map or include an HD map together with the map. Map information may be provided to have various information and data included in the above-described object and environment.

The processor 122 may perform overall control of the vehicle 100. The processor 122 may be configured to execute an application and an instruction stored in the memory 120.

In relation to the present disclosure, the processor 122 may perform weight estimation based on an RLS according to the present disclosure by using an application, an instruction, and data stored in the memory 120.

Specifically, the processor 124 may perform processing of determining a forgetting factor based on the number of weight estimations in response to a variation condition being satisfied and generating estimated weight information based on vehicle data by a weight estimation using an RLS based on the determined forgetting factor. The processor 122 may perform processing of updating estimated weight information based on vehicle data by a weight estimation using a forgetting factor that is variably determined based on an increasing number of weight estimations until the number of weight estimations reaches a threshold number of estimations. In addition, the processor 122 may implement processing of setting a fixed forgetting factor in response to the number of weight estimations reaching the threshold number of estimations and updating estimated weight information based on vehicle data by a weight estimation using the fixed forgetting factor. Herein, the update of estimated weight information may be processed to generate filtered estimated weight information by applying an adaptive rate-limit filter to the estimated weight information.

In the present disclosure, the processor 122 may be implemented as a single processing module that executes the above-described processing related to weight estimation and processing of various vehicle operations. As another example, the processor 122 may have the above-described processing as distributed processing over a plurality of processing modules. For example, the processor 122 may include a vehicle control unit (VCU), a motor control unit (MCU), an electric brake system (EBS) and a transmission control unit (TCU) and handle the above-described processing according to each corresponding module in a distributed manner.

In the present disclosure, for convenience of explanation, even if the processor 124 including a plurality of processing modules performs the above-described processes, the processor 124 illustrated in FIG. 2 is described to commonly refer to the plurality of processing modules.

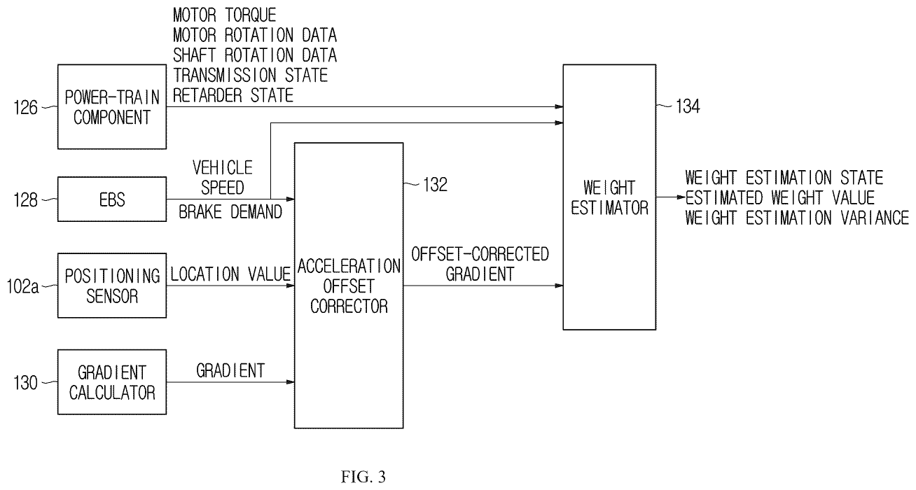

FIG. 3 is a block diagram of a system that implements weight estimation in a vehicle.

FIG. 3 mainly illustrates individual modules for weight estimation in FIG. 2 and detailed functional modules of the processor 124. The system may include the power-train component 126, an electronic braking system (EBS) 128, the positioning sensor 102a, a gradient calculator 130, an acceleration offset corrector 132, and a weight estimation unit 134. Herein, the gradient calculator 130, the acceleration offset corrector 132 and the weight estimation unit 134 may be designed to be implemented in the processor 122.

The power-train component 126 may output vehicle data from a specific module exemplified in FIG. 2, for example, data used in a longitudinal dynamics model, while the vehicle 100 is being used. For example, the power-train component 126 may output, as vehicle data, a motor torque, motor rotation data, shaft rotation data, a transmission state, a retarder state, and the like. The transmission state may include whether transmission is present or not, a gear ratio and the like, and the retarder state may include whether or not there is an operation of the retarder 124 corresponding to an assist brake device. Although not illustrated in FIG. 3, a vehicle operation state, which is a type of vehicle data, is provided to the weight estimation unit 134, and the vehicle operation state may be a state in which the start-up of the vehicle 100 is turned from off to on. The EBS 128 may output a value detected from the brake demand level sensor 102c, which functions as a brake pedal sensor, and a vehicle speed as vehicle data. Based on a value obtained from the slope sensor 102b, the gradient calculator 130 may provide a gradient of the vehicle 100 or a road as vehicle data. The acceleration offset corrector 132 may be used to correct a bias and an error that may occur in the gradient calculator 130 by comparing the positioning sensor 102a and the slope sensor 102b that are mounted in the vehicle 100. The weight estimation unit 134 may generate ultimate estimated weight information based on vehicle data. For example, the estimated weight information may include an estimated weight value, a weight estimation variance, a weight estimation state, a weight estimation standard deviation, and various types of weight-related data.

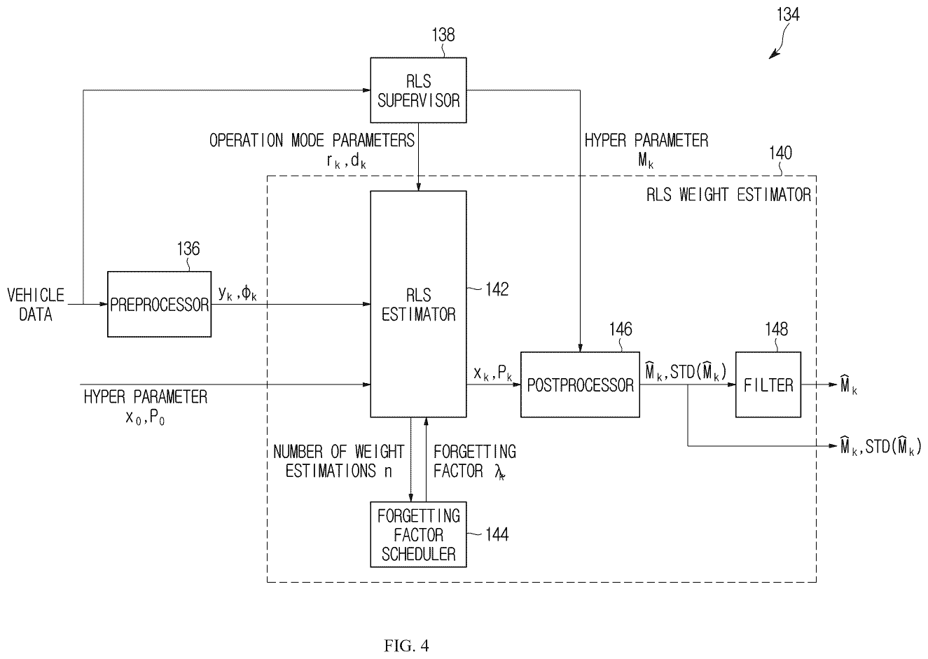

FIG. 4 is a view showing functional modules of a weight estimation unit. FIG. 4 shows detailed functional modules of the weight estimation unit 134 of FIG. 3.

The weight estimation unit 134 may include a preprocessor 136, an RLS supervisor 138, and an RLS weight estimator 140. In the present disclosure, the RLS weight estimator 140 may be abbreviated to the weight estimator 140.

The preprocessor 136 may convert the vehicle data listed in FIG. 2 to a predetermined form of vehicle state information such as a parameter value (e.g., yₖ, Φₖ) of a longitudinal dynamics model.

The RLS supervisor 138 may check, based on vehicle data, whether or not there is an update request of weight estimation for the weight estimator 140 and request an update of weight estimation to the weight estimator 140. In addition, the RLS supervisor 138 may check, based on vehicle data, a vehicle operation state such as initial start-up and transmit a reset state related to whether or not there is an RLS reset to the RLS estimator 142. The RLS supervisor 138 may check whether or not a difference of time-series estimated weight information is greater than a threshold difference. The RLS supervisor 138 may determine whether or not a variation condition for variably adjusting a forgetting factor is satisfied, according to a reset state and a difference of estimated weight information. In case the variation condition occurs, the RLS supervisor 138 may transmit a message related to satisfaction of the variation condition to the weight estimator 140.

The weight estimator 140 may perform a weight estimation that generates estimated weight information based on vehicle state information. Specifically, the weight estimator 140 may include an RLS estimator 142, a forgetting factor scheduler 144, a postprocessor 146 and a filter 148.

The RLS estimator 142 may generate an estimated value with a predetermined format such as xₖ pₖ based on vehicle state information by using a forgetting factor that is provided by the forgetting factor scheduler 144. Hereinafter, the subscript k in various parameters is a discretized time index of weight estimation that is performed in time series in the weight estimator 140 or the number of weight estimations, and in the present disclosure, it may be referred to as a step index.

When the variation condition is satisfied, until the number of weight estimations reaches the threshold number of estimations, the forgetting factor scheduler 144 may variably determine a forgetting factor based on the increasing number of weight estimations and provide the determined variable forgetting factor to the RLS estimator 142. In other words, the variable forgetting factor may be updated based on a current quantity of weight estimations that have been applied to the vehicle data up that point in time. When the number of weight estimations reaches the threshold number of estimations or the variation condition is not satisfied, the forgetting factor scheduler 144 may set a fixed forgetting factor and deliver the fixed forgetting factor to the RLS estimator 142. A detailed process of determination related to a variable forgetting factor and a fixed forgetting factor in the forgetting factor scheduler 144 will be described below.

The postprocessor 146 may calculate estimated weight information based on an estimated value with a predetermined format from the RLS estimator 142. For example, the estimated weight information may include an estimated weight, an estimated weight variance, an estimated weight standard deviation, and various types of weight-related data.

The filter 148 may filter estimated weight information and output the filtered estimated weight information in order to reduce variability of values of estimated weight information that is successively output. For example, an adaptive rate-limit filter may be used for the filter 148. The operation of the filter 148 will be described in detail below.

The longitudinal dynamics model for generating vehicle state information based on vehicle data, as described above, will be described through Equation 1 below. In the present disclosure, the longitudinal dynamics model may be referred to as a longitudinal dynamics equation.

$${\dot{v}}_{Lon} + g ( μ cos ( θ ) + sin ( θ ) ) = ( \frac{{g}_{gbx} {g}_{rear}}{{r}_{tire}} ( ϵ ( τ , {ω}_{in} , {ω}_{out} ) τ - J \dot{ω} ) - \frac{1}{2} {C}_{d} ρ {Av}^{2} ) \frac{1}{M} \qquad [ Equation 1 ]$$

In Equation 1, parameters have the following meaning.

\dot{v}_{Lon} is a change rate of a longitudinal velocity and may be estimated using a Kalman filter based on a vehicle speed. θ may be an offset-corrected gradient. In a specific situation like vehicle breakdown, a gradient including an offset may be input as θ for a predetermined time. In this case, if the number of corrections (or the number of estimations) of the acceleration offset corrector 132 increases, it may be determined that correction is normally performed. g is the gravitational acceleration of 9.8 m/s², and μ may be a rolling resistance constant such as 0.008. In the case of a vehicle with a transmission, g_{gbx} may be a gear ratio of a current transmission stage, and in the case of a vehicle with a decelerator, it may be a deceleration ratio. gᵣₑₐᵣ is a rear axle ratio and may be defined as 1 when there is no separate rear axle. rₜᵢᵣₑ is a tire dynamic radius, which may be 0.5 m for example, and ϵ(Σ, ωᵢₙ, ωₒᵤₜ) is power-train efficiency (0-1) that may be experimentally determined. τ may be a motor torque Nm, wᵢₙ may be an input-shaft rotations per minute (RPM), and wₒᵤₜ may be an output-shaft RPM. J may be an effective inertia moment (kg·m2) of power-train, which may be experimentally determined. \dot{ω} is an angular acceleration (rad/s2) and may be calculated from a motor RPM.

C_{d} is an aerodynamic coefficient and may be experimentally determined. ρ may be determined by atmospheric density, altitude and ambient temperature. A is an effective front area of a vehicle, υ is a relative speed of the vehicle with respect to the ambient air and depends on the impact of wind speed, but the wind speed may be assumed to be 0 when weight is estimated. M may be the mass (kg) of a vehicle.

The weight estimator 140 may include a recursive least square (RLS) estimator that uses RLS with forgetting factor. The RLS with forgetting factor will be described below.

$$y = Φ x \qquad [ Equation 2 ]$$

RLS may be expressed in a linear parametric form as Equation 2 using a given observed value y, an estimating x and a function Φ. In this case, a RLS estimation may be calculated by a series of equations, specifically, \hat{x}(k) =\hat{x}(k−1)+L(k)(y(k)−Φ^{T}(k)\hat{x}(k−1)), L(k)=P(k−1)Φ(k)(λₖ+Φ^{T}(k)P(k−1)Φ(k))⁻¹,

$$P ( k ) = \frac{1}{{λ}_{k}} ( 1 - L ( k ) {Φ}^{T} ( k ) ) P ( k - 1 ) .$$

In the equations, k may mean the number of weight estimations performed in a weight estimator, the number of updates of weight estimation or a step index of weight estimation. Here, the forgetting factor λₖ may determine a forgetting degree of past observation information. If λ=1, an RLS algorithm may be implemented not to forget past observation information or past estimation result at all. As λ approaches 0, RLS may aggressively forget the past estimation result and determine observation information x that is as close to the present as possible. In the present disclosure, the weight of a vehicle is to be ultimately estimated, the variable x to be estimated may be defined as a reciprocal of scaled mass as shown in Equation 3.

$$x = \frac{{M}_{0}}{M} \qquad [ Equation 3 ]$$

M₀ is reference mass and may be suitably selected by considering a numerical error of an algorithm. The longitudinal dynamics equation according to Equation 1 may be arranged into

$$y = {\dot{v}}_{Lon} + g ( μ cos ( θ ) + sin ( θ ) ) and Φ = \frac{1}{{M}_{0}} ( \frac{{g}_{gbx} {g}_{rear}}{{r}_{tire}} ( ϵ ( τ , {ω}_{in} , {ω}_{out} ) τ - J \dot{ω} ) - \frac{1}{2} {C}_{d} ρ {Av}^{2} )$$

### by Equation 3.

Thus, if RLS and the longitudinal dynamics equation are applied, an estimation x of the weight-related variable x may be obtained. As shown in Equation 4 below, the weight estimation \hat{M} may be obtained through \hat{x}.

$$\hat{M} = \frac{{M}_{0}}{\hat{x}} \qquad [ Equation 4 ]$$

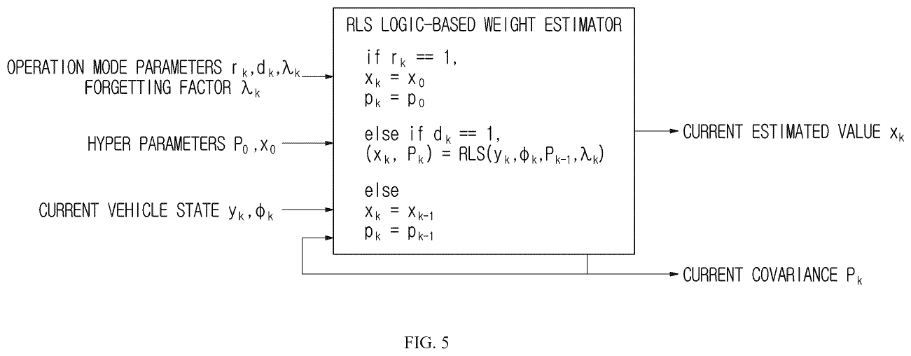

Referring to FIG. 5, the structure of the RLS estimator 142 used in the weight estimator 140 will be described. FIG. 5 is a view showing RLS logic that is applied to a weight estimator.

The RLS estimator 142 may generate a current estimated value based on an operation mode parameter, current vehicle state information, and a past covariance of estimated values and a covariance thereof.

Operation mode parameters rₖ and dₖ transmitted by the RLS supervisor 138 may each indicate a reset state related to whether or not RLS is reset and whether or not update is permitted. The RLS supervisor 138 may transmit rk as 1 in a vehicle operation state like initial start-up and initialize RLS. For example, the RLS supervisor 138 may determine adequacy of the longitudinal dynamics equation based on detection of abnormality of a current sensor state, whether or not a retarder operates and other vehicle data used for weight estimation and output dk as 1.

Meanwhile, because an estimated value x is calculated through RLS, it is not necessary to convert x to a vehicle weight. Specifically, by the above-described equation

$${\hat{M}}_{k} = \frac{{M}_{0}}{{x}_{k}} ,$$

x may be converted to a vehicle weight \hat{M}ₖ. A weight estimation variance may be calculated by

$$P ( {\hat{M}}_{k} ) = P ( {x}_{k} ) \frac{dM}{dx} ,$$

and a weight estimation standard deviation may be obtained by

$$S T D ( {\hat{M}}_{k} ) = \vert \frac{d M}{d x} \vert \sqrt{P ( {x}_{k} )} = \frac{{\hat{M}}_{k}}{x} \sqrt{P ( {x}_{k} )} .$$

Meanwhile, if the forgetting factor λ is small and an input observed value yk or a noise level of the function Φₖ or a level of effect not included in the model is high, chattering of an output result of RLS may be caused. In the present disclosure, the chattering needs to be prevented by using an RLS result with λ being set to be small so that a convergence speed may be improved and fail-safety may be achieved for a situation where weight estimation is impossible. A simple lowpass filter is capable of preventing chattering, but the use of the simple lowpass filter may not be suitable when a sudden change of filter output is physically acceptable like initial weight estimation or a sudden change of vehicle weight caused by a fallen object. Accordingly, as described above, the filter 148, which is coupled with the RLS estimator 142 and the postprocessor 146, may be an adaptive rate-limit filter. In addition to chattering prevention, such a filter may have a filter output quickly approach a filter input according to a specific situation. The adaptive rate-limit filter may be a filter that prevents an output from being excessively changed from a previous output at each operation cycle time of individual logic.

To sum up, the weight estimator 140 may perform RLS estimation based on hyper parameters P₀, x₀ and M₀, operation mode parameters rₖ, dₖ determined based on vehicle data and a forgetting factor λₖ that is provided in the forgetting factor scheduler 144. The postprocessor 146 may calculate an estimated weight and a standard deviation based on an output value of the RLS estimator 142. As the filter 148 uses an adaptive rate-limit filter for chattering prevention, a filtered estimated weight M̅ₖ may be calculated. The ultimate output of each weight estimator may be weight estimation values \hat{M}ₖ and M̅ₖ and a standard deviation STD (\hat{M}ₖ) of the current estimation.

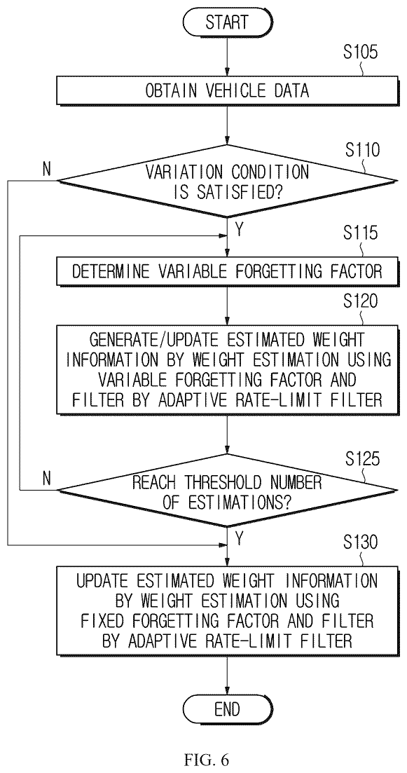

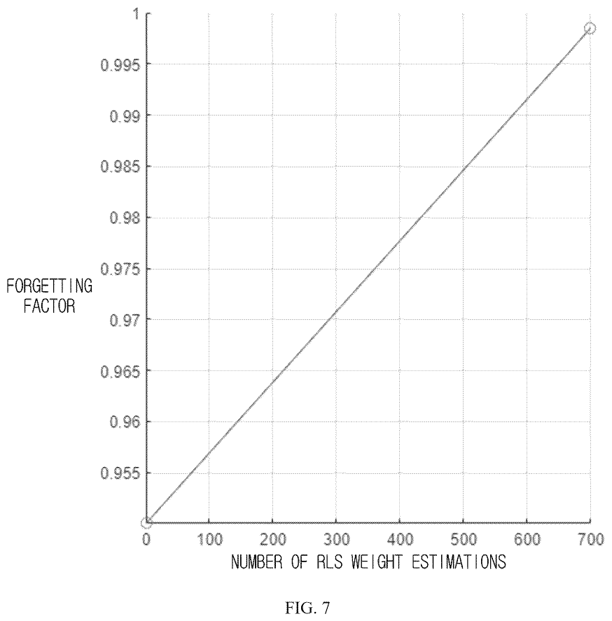

Hereinafter, the weight estimation method according to FIG. 3 and FIG. 4 will be described in detail through FIG. 6 and FIG. 7. The weight estimation method may be processed mainly by the processor 122 of the vehicle 100, and the processor 122 and the vehicle 100 may be described interchangeably. FIG. 6 is a flowchart of a method for estimating a weight.

First, the processor 122 of the vehicle 100 may be operated by the use of a user and obtain vehicle data (S105).

For example, the use of the user may be that the start-up of the vehicle 100 is turned from off to on and becomes capable of driving. The vehicle data may be the data described in FIG. 3, that is, data used in a longitudinal dynamics equation.

Next, the processor 122 may determine whether or not vehicle data satisfies a variation condition, in order to determine whether or not to use a variable forgetting factor in the weight estimator 140 (S110).

The satisfaction of the variation condition may be determined according to any one of a vehicle state identified through the vehicle data or a difference of time-series estimated weight information. For example, the variation condition according to the vehicle state may be satisfied by a reset state caused by turning on the start-up of the vehicle.

A reset state is an initial start-up state where start-up is turned from off to on (e.g., transitions from an OFF state to an ON state), and it may mean that rₖ is changed to 1. When start-up is turned on, because weight estimation changes by a large amount until converging on the real weight of the vehicle 100, the weight estimation needs to be performed by mainly considering a past estimated weight relatively close to the present. Accordingly, an initial assumption immediately after start-up is on may have a relatively lower weight and be reflected in a weight estimation result, and relatively recent observed values may have a relatively higher weight and be reflected in the weight estimation result. To this end, a forgetting factor used for RLS weight estimation may vary so that a weight may be estimated based on observed values close to the present immediately after start-up is on and relatively remoter past observed values may also be considered as the number of weight estimations increases after start-up is on. A variation condition may be a factor for determining whether or not a situation requires variation of a forgetting factor.

In addition, a variation condition according to a difference between estimated weight information may be satisfied, for example, when a difference between time-series estimated weight information (e.g., estimated weight information at two different time frames) is greater than a threshold difference. Specifically, if a difference between estimated weight information of the weight estimator 140, which is successively output in time series, is greater than a threshold difference, a variation condition according to the difference may be considered to occur. The difference may be caused by a sudden change of weight of the vehicle 100 due to goods being loaded while the vehicle 100 stops with start-up being turned on. In addition, the difference may be caused by a sudden change of weight due to fallen goods while the vehicle 100 is running. When the difference is greater than the threshold difference, because weight estimation changes by a large amount until converging on the real weight of the vehicle 100, the weight estimation needs to use a past estimated weight that is as close to the present as possible. Accordingly, in a situation where a sudden change of weight occurs, relative past observation information is reflected in RLS with a relatively low weight, and RLS weight estimation may be performed by putting a higher weight on observed values that are close to the present. To this end, a weight may be estimated based on observed values that are close to the present, and the number of weight estimations increased after the situation change, it may vary to consider remoter past observed values.

Whether or not a variation condition is satisfied may be determined by the RLS supervisor 138 or another module of the processor 122 other than the RLS supervisor 138, and a message related to whether or not the variation condition is satisfied may be transmitted to at least one of the RLS estimator 142 and the forgetting factor scheduler 144. When the RLS estimator 142 receives the message, the RLS estimator 142 may transmit the message to the forgetting factor scheduler 144 to request a forgetting factor.

Next, when the variation condition is satisfied and is notified to the forgetting factor scheduler 144, the processor 122 may determine a forgetting factor based on the number of weight estimations by using the forgetting factor scheduler 144 (S115).

The number of weight estimations may mean the number of times when the weight estimator 140 outputs estimated weight information or the number of times when the weight estimator 140 performs RLS state estimation. As the number of weight estimations increases, a forgetting factor may be set to be variable. As described above at step S110, the forgetting factor scheduler 144 may adjust the forgetting factor so that the forgetting factor may be decreased immediately after the variation condition occurs, and thus existing observed values may be considered with a lower weight in the RLS estimator 142, and observed values obtained after a predetermined number of times after the variation condition occurs may be considered with a relatively higher weight.

To sum up, the forgetting factor may be adjusted so that an initial weight estimation may be aggressively updated immediately after the variation condition occurs and a weight estimation may be conservatively updated after being mature. Herein, the maturity of weight estimation may mean a state in which estimated weight values have entered a convergence state.

To implement what is described above, a forgetting factor may be increased to have a low forgetting feature along with an increase in the number of weight estimations. As an example, a forgetting factor may be increased in proportion to an increase in the number of weight estimations.

As another example, a forgetting factor may be increased by an intermittent value (e.g., a discrete value) according to each section in the number of weight estimations.

Meanwhile, in relation to steps S125 and S130 described below, if the number of weight estimations (e.g., a total quantity of weight estimations that have been applied to the vehicle data) reaches the threshold number of estimations, a forgetting factor may be set to a fixed value that is no longer variable. The threshold number of estimations may be estimated to be a number corresponding to a state, in which estimated weight values are estimated in a convergence state, and may be determined according to a design specification. A fixed forgetting factor may be set to be greater than a variable forgetting factor so that the fixed forgetting factor has a lower forgetting feature than the variable forgetting factor.

If the above description is explained by a concrete example, a forgetting factor λ(n) may vary according to a linear function described by Equation 5.

$$λ ( n ) = \{ \begin{matrix}{λ}_{min} + \frac{n}{{n}_{c}} ( {λ}_{max} - {λ}_{min} ) , & n < {n}_{c} \\ {λ}_{max} , & n \geq {n}_{c}\end{matrix} \qquad [ Equation 5 ]$$

Here, n and n_{c} may be the number of weight estimations and a threshold number of estimations, respectively. Here, λₘᵢₙ=0.95 and λₘₐₓ=0.999 may be set, and the number of weight estimations may be set as n_{c}=700. As exemplified in FIG. 7, in case the number of weight estimations is smaller than the threshold number of estimations, the forgetting factor may be linearly increased. FIG. 7 is a view exemplifying a process of determining a forgetting factor. However, parameters set to example values may be experientially determined by accuracy of a dynamics model, sensor precision, tolerance, maximum weight difference and the like.

Next, according to an update request of the RLS supervisor 138, the processor 122 may perform an RLS weight estimation based on a variable forgetting factor by the RLS estimator 142 and the postprocessor 146 and filter estimated weight information by the filter 148.

The update request (dₖ of FIG. 4 and FIG. 5) may be referred to as requesting an update of weight estimation to the weight estimator 140. The update request may be determined by a start-up state, an operation state of a module of the vehicle 100 for outputting vehicle data, and applicability the operation state to a longitudinal dynamics equation. The operation state of the module of the vehicle 100 may indicate a normal state or a failure state. In a start-up on state and the normal state, the update request may occur (dₖ=1), and otherwise, the update request may not occur (dₖ=0). As for the applicability of the equation, if modeling may be implemented because the operation state of the module of the vehicle 100 is applicable to the above-described longitudinal dynamics equation, the update request may occur (dₖ=1). For example, driveline engaged, lockup release of a torque converter, operation of a hydrodynamic retarder, and operation of a service brake may be operation states for which modeling by the dynamics equation is difficult.

Furthermore, it may be determined whether or not a vehicle speed update is permitted. In addition, as the impact of observation noise on the error of x increases, if model data Φ in y=Φx according to Equation 2 is greater than a constant ci that is a threshold model value, an update of weight estimation may be permitted. A situation related to braking or stopping the vehicle 100 does not permit the update of weight estimation, and a forgetting factor may not change for a time required for the situation. The processor 122 may inform a user that a weight estimation with the forgetting factor applied in the situation is abnormal.

After the estimated weight information has been updated, the processor 122 may control the vehicle based on the estimated weight information. For example, steering, acceleration, brake, lane centering, adaptive cruise control, etc. may be applied to the vehicle based on the estimated weight information. For example, if the updated estimated weight information indicates an estimated weight that is greater than the weight initially estimated, the timing of the braking may be adjusted (e.g., braking sooner), the steering angle may be increased, etc.

The above description focuses on the update of estimated weight information, but in the present disclosure, a first weight estimation may be referred to as generation of estimated weight information, and second and later weight estimations may be referred to as update of the estimated weight information to be distinguished from the generation. However, for convenience of explanation, generation and update are not limited to the above-described meanings, and even a first weight estimation may be described as update.

Referring to FIG. 4 and FIG. 5, at an update request (dₖ=1), the processor 122 may generate vehicle state information yₖ and Φₖ from vehicle data by using the preprocessor 136. The processor 122 may output an estimated value with a predetermined format and covariance xₖ and Pₖ based on the vehicle state information by the RLS estimator 142 that uses a forgetting factor that is variably determined. Next, the processor 122 may generate estimated weight information \hat{M}ₖ and STD (\hat{M}ₖ) based on the estimated value and the covariance by using the postprocessor 146. In the above-described process, the estimated weight information may be generated or updated based on vehicle data by the RLS estimator 142 to which the variable forgetting factor is applied.

Next, the processor 122 may process the estimated weight information and generate filtered estimated weight information by the filter 148 that uses an adaptive rate-limit filter.

Current estimated weight information, which is output as latest information from the postprocessor 146, may be filtered so that a difference between the current estimated weight information and previous filtered estimated weight information is between an upper limit value and a lower limit value of an adaptive rate-limit filter. The upper limit value and the lower limit value may be determined according to a difference between previous estimated weight information not filtered yet and previous filtered estimated weight information.

Specifically, estimated weight information \hat{M}ₖ may be filtered so that Equation 6 below is applicable to an adaptive rate-limit filter output value of a previous step M̅ₖ and a current filter output value M̅ₖ. Here, f_{u,k} and f_{l,k} may be an upper limit value and a lower limit value of an adaptive rate-limit filter, respectively.

$${f}_{u , k} \geq {\overline{M}}_{k} - {\overline{M}}_{k - 1} \geq {f}_{l , k} , {f}_{u , k} \geq 0 , {f}_{l , k} \leq 0 ( here , {\overline{M}}_{0} = {\overline{M}}_{0} ) \qquad [ Equation 6 ]$$

A rate limit related to the upper and lower limits of the filter may be adaptively determined by a filter input/output difference. That is, if the difference between the input and output of the filter is large, f_{u,k} and f_{l,k} may be increased to make the filter output quickly follow a weight estimation result, and if the difference is small, f_{u,k} and f_{l,k} may be decreased to suppress an unnecessary fluctuation of the filter output. This may be expressed by ΔM_{K}=|\hat{M}ₖ−M̅ₖ, f_{u,k}|,f_{u,k}=fᵤ(ΔMₖ₋₁), f_{u,k}=fₗ(ΔMₖ₋₁). Herein, the functions f_{u,k} and f_{l,k} may be experientially determined. The weight estimator 140 may be set with an operation cycle of 10 Hz to operate once every 0.1 second, and for example, if ΔMₖ=10000 kg, then f_{u,k}=f_{l,k}=200 kg, and the filter output of weight estimation may vary within a slope range of 2,000 kg per second.

The above-described functions f_{u,k} and f_{l,k}, that is, filter-rate limits are a piecewise linear function, which may be determined like Equation 7 below. In an actual application, tuning may be needed because of a noise level of each sensor or a characteristic of a vehicle.

$${f}_{u} ( Δ M ) = {f}_{l} ( Δ M ) = {c}_{i - 1} + \frac{Δ M - Δ {M}_{i - 1}}{Δ {M}_{i} - Δ {M}_{i - 1}} ( {c}_{i} - {c}_{i - 1} ) , {c}_{i} \geq Δ M \geq {c}_{i - 1} \qquad [ Equation 7 ]$$

C₁ is a reference position that varies the linear function according to ΔM, and it may be i≥2.

If current estimated weight information \hat{M}ₖis greater than previous filtered estimated weight information M̅ₖ₋₁ by the upper limit value f_{u,k} or more, the filter 148 may generate filtered estimated weight information M̅ₖ=M̅ₖ₋₁+f_{u,k} by limiting current estimated weight information to a sum of the previous filtered estimated weight information and the upper limit value. If current estimated weight information is greater than previous filtered estimated weight information by less than the upper limit value, the filter 148 may generate filtered estimated weight information \hat{M}ₖ=M̅ₖ₋₁ by limiting the current estimated weight information to the previous filtered estimated weight information. To sum up, in case \hat{M}ₖ>M̅ₖ₋₁, if \hat{M}ₖ>M̅ₖ₋₁+f_{u,k} then M̅ₖ=M̅ₖ₋₁+f_{u,k}, else \hat{M}ₖ=M̅ₖ₋₁.

If current estimated weight information \hat{M}ₖ is smaller than previous filtered estimated weight information M̅ₖ₋₁ by the lower limit value f_{l,k} or more, the filter 148 may generate filtered estimated weight information M̅ₖ=M̅ₖ₋₁−f_{l,k} by limiting the current estimated weight information to a value obtained by subtracting the lower limit value from the previous filtered estimated weight information. If current estimated weight information is smaller than previous filtered estimated weight information by less than the lower limit value, the filter 148 may generate filtered estimated weight information M̅ₖ=M̅ₖ₋₁ by limiting the current estimated weight information to the previous filtered estimated weight information. To sum up, in case \hat{M}ₖ<M̅ₖ₋₁, if \hat{M}ₖ<M̅ₖ₋₁−f_{l,k} then M̅ₖ=M̅ₖ₋₁−f_{l,k}, else \hat{M}ₖ=M̅ₖ₋₁−f_{l,k}.

Next, the processor 122 may determine whether or not the number of weight estimations reaches the threshold number of estimations in order to update the filtered estimated weight information (S125), and if the number of weight estimation has not reached the threshold number of estimations (N of S125), the processor 122 may repeat steps S115 and S120 to update a weight estimation based on a variable forgetting factor.

If the number of weight estimations reaches the threshold number of estimations (Y of S125) or the variation condition does not occur and is not satisfied (N of S110), the processor 122 may apply a fixed forgetting factor described at step S115, for example, λₘₐₓ(n≥n_{c}) according to Equation 5 to the RLS estimator 142 and update estimated weight information based on vehicle information according to an update request (S130).

A weight estimation based on an RLS using a forgetting factor may be performed in the process described at step S120. Regardless of a predetermined situation and a vehicle state, when the filter 148 using adaptive rate-limit filtering is operated, the estimated weight information according to step S130 may be filtered and output on a regular basis.

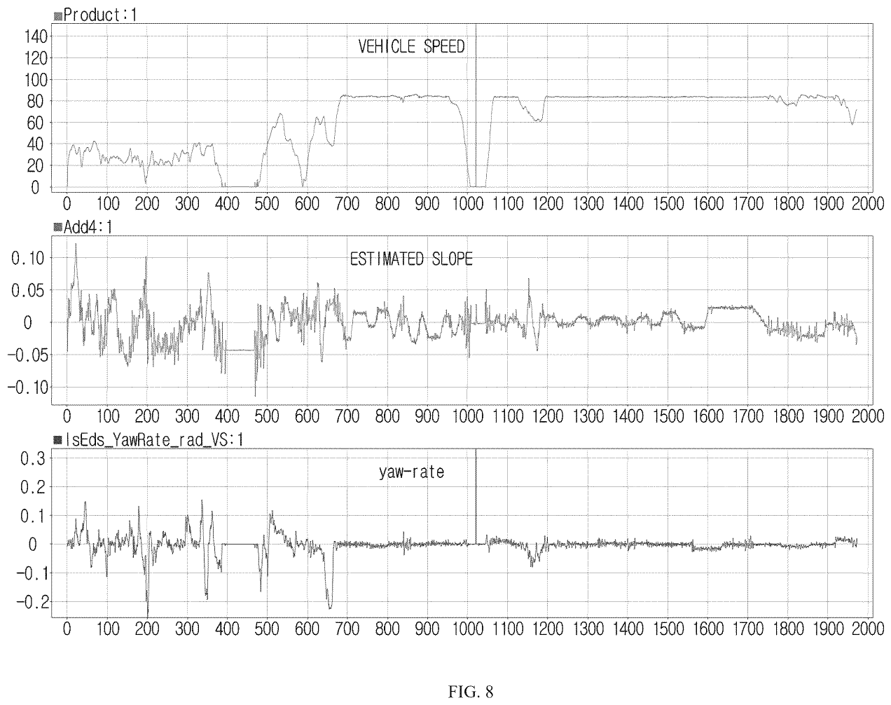

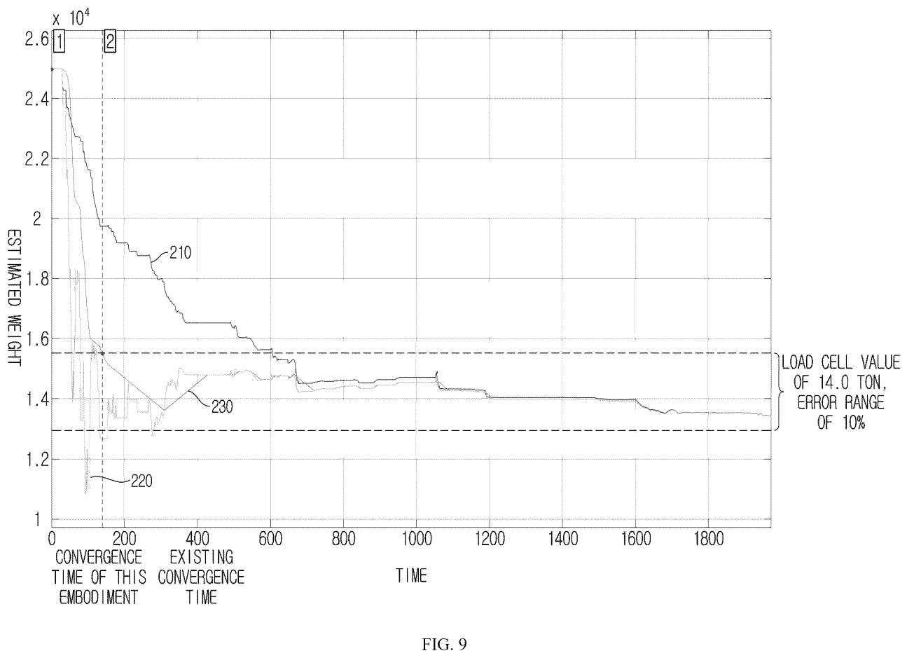

Hereinafter, referring to FIG. 8 and FIG. 9, the advantages of one or more example embodiments will be described through results of real weight estimations to which an existing weight estimation method and the weight estimation method according to the present disclosure. FIG. 8 is a view showing vehicle data used in an existing weight estimation method and a weight estimation method according to the present disclosure. FIG. 9 is a view showing data of results of application of the existing weight estimation method and the weight estimation method according to the present disclosure.

As shown in FIG. 8, vehicle data used for the existing weight estimation method and the weight estimation method according to one or more example embodiments are data obtained from a large hydrogen truck with an empty vehicle weight of 14.1 tons that runs on the Seohaean expressway in South Korea. FIG. 8 is vehicle data over time, showing vehicle speeds, estimated slopes and yaw-rates.

FIG. 9 shows diagrams related to an estimated weight 210 according to the existing weight estimation method, an estimated weight 220 according to the weight estimation method using a variable forgetting factor, and an estimated weight 230 according to the weight estimation method using a variable forgetting factor and an adaptive rate limit.

As shown in FIG. 9, the existing weight estimation method shown in the diagram 210 shows that the estimated weight converges on the real weight after about 600 seconds, but as shown in the diagram 220, the estimated weight may converge on the real weight in about 140 seconds, and thus the convergence time of the present disclosure shows 77% decrease as compared to that of some other implementations. Furthermore, when the adaptive rate limit is additionally applied, as shown in the diagram 230, it can be known that chattering of weight estimation is prevented.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

A method may be performed by an apparatus, of a vehicle, for a weight estimation based on a recursive least square (RLS) with a forgetting factor. The weight estimation method may comprise: determining a forgetting factor based on the number of weight estimations in response to satisfaction of a variation condition; generating estimated weight information based on vehicle data by a weight estimation using a RLS based on the determined forgetting factor; and updating the estimated weight information based on the vehicle data by the weight estimation using the forgetting factor that is variably determined based on an increasing number of weight estimations, until the number of weight estimations reaches a threshold number of estimations.

The forgetting factor may be increased to have a low forgetting feature along with an increase in the number of weight estimations.

The forgetting factor may be increased in proportion to an increase in the number of weight estimations.

The method may further comprise, in response to the number of weight estimations reaching the threshold number of estimations, setting fixedly the forgetting factor and updating the estimated weight information based on the vehicle data by the weight estimation using the fixed forgetting factor.

The fixed forgetting factor may be set to be greater than a variable forgetting factor so that that the fixed forgetting factor has a lower forgetting feature than the variable forgetting factor.

The satisfaction of the variation condition may be determined according to any one of a vehicle state or a difference between time-series estimated weight information, the variation condition according to the vehicle state is satisfied by a reset state in which start-up of a vehicle is turned from off to on, and the variation condition according to the difference between the estimated weight information is satisfied when the difference between the time-series estimated weight information is greater than a threshold difference.

The updating of the estimated weight information may further comprise generating filtered estimated weight information by applying an adaptive rate-limit filter to the estimated weight information.

The generating of the filtered estimated weight information may comprise generating the filtered estimated weight information by filtering current estimated weight information so that a difference between the current estimated weight information and filtered previous estimated weight information is between an upper limit value and a lower limit value of the adaptive rate-limit filter, and wherein the upper limit value and the lower limit value is determined according to a difference between previous estimated weight information before filtering and the filtered previous estimated weight information.

The generating of the filtered estimated weight information may comprise: generating the filtered estimated weight information by limiting the current estimated weight information to a sum of the filtered previous estimated weight information and the upper limit value, when the current estimated weight information is greater than the filtered previous estimated weight information by the upper limit value or more; and generating the filtered estimated weight information by limiting the current estimated weight information to the filtered previous estimated weight information, when the current estimated weight information is greater than the filtered previous estimated weight information by less than the upper limit value.

The generating of the filtered estimated weight information may comprise: generating the filtered estimated weight information by limiting the current estimated weight information to a value obtained by subtracting the lower limit value from the filtered previous estimated weight information, when the current estimated weight information is smaller than the filtered previous estimated weight information by the lower limit value or more; and generating the filtered estimated weight information by limiting the current estimated weight information to the filtered previous estimated weight information, when the current estimated weight information is smaller than the filtered previous estimated weight information by less than the lower limit value.

A vehicle may comprise: a memory configured to store at least one instruction that controls the vehicle; and a processor configured to execute the at least one instruction stored in the memory, wherein the processor may be further configured to: determine a forgetting factor based on the number of weight estimations in response to satisfaction of a variation condition, generate estimated weight information based on vehicle data by a weight estimation using a RLS based on the determined forgetting factor, and update the estimated weight information based on the vehicle data by the weight estimation using the forgetting factor that is variably determined based on an increasing number of weight estimations, until the number of weight estimations reaches a threshold number of estimations.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus of a vehicle, the method comprising:
determining, based on a quantity of one or more weight estimations that have been applied to vehicle data and based on a variation condition being satisfied, a forgetting factor;
determining estimated weight information of the vehicle by applying, to the vehicle data, a weight estimation that is based on recursive least squares (RLS) associated with the forgetting factor;
updating the estimated weight information by repeatedly applying, to the vehicle data and until a total quantity of weight estimations that have been applied to the vehicle data reaches a threshold value, one or more additional weight estimations that are based on RLS associated with a variable forgetting factor, wherein the variable forgetting factor is updated based on a current quantity of weight estimations that have been applied to the vehicle data; and
controlling, based on the updated estimated weight information, the vehicle.

2. The method of claim 1, wherein, as the current quantity of weight estimations that have been applied to the vehicle data increases, the variable forgetting factor increases and a forgetting feature of the variable forgetting factor decreases.

3. The method of claim 1, wherein an increase in the variable forgetting factor is proportional to an increase in the current quantity of weight estimations that have been applied to the vehicle data.

4. The method of claim 1, further comprising, based on the total quantity of weight estimations reaching the threshold value:
determining a fixed forgetting factor by stopping updating the variable forgetting factor; and
updating the estimated weight information by applying, to the vehicle data, an additional weight estimation that is based on RLS associated with the fixed forgetting factor.

5. The method of claim 4, wherein the fixed forgetting factor is greater than the variable forgetting factor, and wherein the fixed forgetting factor has a lower forgetting feature than the variable forgetting factor.

6. The method of claim 1, further comprising determining whether the variation condition is satisfied, based on at least one of:
a difference in the estimated weight information between two time frames being greater than a threshold difference, or
a reset state in which the vehicle transitions from an OFF state to an ON state.

7. The method of claim 1, wherein the updating of the estimated weight information comprises:
determining filtered estimated weight information by applying an adaptive rate-limit filter to the estimated weight information.

8. The method of claim 7, wherein the determining of the filtered estimated weight information comprises determining the filtered estimated weight information by filtering current estimated weight information such that a difference between the current estimated weight information and previous filtered estimated weight information is between an upper limit value and a lower limit value of the adaptive rate-limit filter, and
wherein the upper limit value and the lower limit value are determined according to a difference between previous estimated weight information before filtering and the previous filtered estimated weight information.

9. The method of claim 8, wherein the determining of the filtered estimated weight information comprises at least one of:
determining the filtered estimated weight information by limiting the current estimated weight information to a sum of the previous filtered estimated weight information and the upper limit value, based on the current estimated weight information being greater than the previous filtered estimated weight information by at least the upper limit value; or
determining the filtered estimated weight information by limiting the current estimated weight information to the previous filtered estimated weight information, based on the current estimated weight information being greater than the previous filtered estimated weight information by less than the upper limit value.

10. The method of claim 8, wherein the determining of the filtered estimated weight information comprises at least one of:
determining the filtered estimated weight information by limiting the current estimated weight information to a value obtained by subtracting the lower limit value from the previous filtered estimated weight information, based on the current estimated weight information being less than the previous filtered estimated weight information by at least the lower limit value; or
determining the filtered estimated weight information by limiting the current estimated weight information to the previous filtered estimated weight information, based on the current estimated weight information being less than the previous filtered estimated weight information by less than the lower limit value.

11. A vehicle comprising:
a memory storing at least one instruction; and
a processor configured to execute the at least one instruction stored in the memory to:
determine, based on a quantity of one or more weight estimations that have been applied to vehicle data and based on a variation condition being satisfied, a forgetting factor;
determine estimated weight information of the vehicle by applying, to the vehicle data, a weight estimation that is based on recursive least squares (RLS) associated with the forgetting factor;
update the estimated weight information by repeatedly applying, to the vehicle data and until a total quantity of weight estimations that have been applied to the vehicle data reaches a threshold value, one or more additional weight estimations that are based on RLS associated with a variable forgetting factor, wherein the variable forgetting factor is updated based on a current quantity of weight estimations that have been applied to the vehicle data; and
control, based on the updated estimated weight information, the vehicle.

12. The vehicle of claim 11, wherein, as the current quantity of weight estimations that have been applied to the vehicle data increases, the variable forgetting factor increases and a forgetting feature of the variable forgetting factor decreases.

13. The vehicle of claim 11, wherein an increase in the variable forgetting factor is proportional to an increase in the current quantity of weight estimations that have been applied to the vehicle data.

14. The vehicle of claim 11, wherein the processor is configured to execute the at least one instruction stored in the memory further to, based on the total quantity of weight estimations reaching the threshold value:
determining a fixed forgetting factor by stopping updating the variable forgetting factor; and
update the estimated weight information by applying, to the vehicle data, an additional weight estimation that is based on RLS associated with the fixed forgetting factor.

15. The vehicle of claim 14, wherein the fixed forgetting factor is greater than the variable forgetting factor, and wherein the fixed forgetting factor has a lower forgetting feature than the variable forgetting factor.

16. The vehicle of claim 11, wherein the processor is configured to execute the at least one instruction stored in the memory further to determine whether the variation condition is satisfied, based on at least one of:
a difference in estimated weight information between two time frames being greater than a threshold difference, or
a reset state in which the vehicle transitions from an OFF state to an ON state.

17. The vehicle of claim 11, wherein the processor is configured to execute the at least one instruction stored in the memory to update the estimated weight information by:
determining filtered estimated weight information by applying an adaptive rate-limit filter to the estimated weight information.

18. The vehicle of claim 17, wherein the processor is configured to execute the at least one instruction stored in the memory to determine the filtered estimated weight information by determining the filtered estimated weight information by filtering current estimated weight information such that a difference between the current estimated weight information and previous filtered estimated weight information is between an upper limit value and a lower limit value of the adaptive rate-limit filter, and
wherein the upper limit value and the lower limit value are determined according to a difference between previous estimated weight information before filtering and the previous filtered estimated weight information.

19. The vehicle of claim 18, wherein the processor is configured to execute the at least one instruction stored in the memory to determine the filtered estimated weight information by at least one of:
determining the filtered estimated weight information by limiting the current estimated weight information to a sum of the previous filtered estimated weight information and the upper limit value, based on the current estimated weight information being greater than the previous filtered estimated weight information by at least the upper limit value or more; or
determining the filtered estimated weight information by limiting the current estimated weight information to the previous filtered estimated weight information, based on the current estimated weight information being greater than the previous filtered estimated weight information by less than the upper limit value.

20. The vehicle of claim 18, wherein the processor is configured to execute the at least one instruction stored in the memory to determine of the filtered estimated weight information by at least one of:
determining the filtered estimated weight information by limiting the current estimated weight information to a value obtained by subtracting the lower limit value from the previous filtered estimated weight information, based on the current estimated weight information being less than the previous filtered estimated weight information by at least the lower limit value; or
determining the filtered estimated weight information by limiting the current estimated weight information to the previous filtered estimated weight information, based on the current estimated weight information being less than the previous filtered estimated weight information by less than the lower limit value.
